(19) United States
(12) Patent Application Publication
(10) Pub. No.: US 2019/0014739 A1
(43) Pub. Date: Jan. 17, 2019

(54) INTELLIGENT LITTER BOX THAT AUTOMATICALLY CLOSES FOR SAFETY AND ODOR CONTROL

(71) Applicant: Shalom Darmanjian, Gainesville, FL (US)

(72) Inventor: Shalom Darmanjian, Gainesville, FL (US)

(21) Appl. No.: 16/033,666

(22) Filed: Jul. 12, 2018

Related U.S. Application Data
(60) Provisional application No. 62/532,390, filed on Jul. 14, 2017.

(51) Int. Cl. A01K 1/01

(52) U.S. Cl. CPC A01K 1/0107

(57) ABSTRACT

The present invention is a litter box that comprises intelligent components using image recognition and feature points to discern different animals that are authorized or excluded from use. Along with authorizing use of the litter, the litter box automatically closes and opens for access. The invention will also remove and or subvert odors that emanate from the soiled litter. Along with odor suppression, the litter box shall convert into a smaller size in order to relieve the owner of cumbersome dimensions. The litter box also has a user interface on board but can also be used remotely through the internet, cell phones, tablets, and other smart devices. In preferred embodiments, the system shall provide an easy manual or automatic method of cleanup once authorization and detection has been enacted. Another preferred embodiment of the system shall provide frequency and weight of waste for particular animals using the intelligent components to discern the particular animals.

### TECHNICAL FIELD OF THE INVENTION

The present invention relates in general to litter boxes, and, more specifically, to an intelligent litter box that regulates access by opening and closing in order to suppress odor, disinfect contents, monitor frequency and weight of waste, and shrink litter box size.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Litter boxes have long been used for multiple domesticated animals. Unfortunately most litter boxes cannot control the odor released from animal waste. In fact, this odor often discourages animal ownership. The problem is only made worse as the number of animals sharing a litter box increases.

Multi-pet households have the additional issue of cross-contamination of bacteria or other microorganisms when sharing a litter box. The danger is increased if young children or pregnant women dwell in the same household. Cross-contamination occurs mainly under three circumstances: (1) when litter is kicked out of the litter box and tracked throughout house surfaces; (2) direct purposeful contact (inquisitive young child or animal); and (3) during litter changes or scooping of clumps (direct contact).

Additionally, knowing the frequency and weight of animal waste can provide pet owners valuable health information. Currently, there is no reliable way to know when or how often a particular animal relieves itself unless directly observed. There is also no reliable way to distinguish the amount of waste once the litter has wicked up the moisture of the waste (only rough estimates can be determined). The health information is further obscured with multi-pet households, since distinguishing between pets with health issues and those without issues cannot be determined without direct measurement.

There have been prior art attempts to solve the problems described above, though the prior art fails to fully address the problems. The litter boxes described in U.S. Pat. Nos. 8,757,094, and 6,082,302 use simple sensors that detect when an object breaks a line of sight and sets a timer. Once the timer is triggered, the litter box then automatically rakes the waste into a container in order to remove smell and clean litter. Another litter box, disclosed in U.S. Pat. No. 8,347,819 uses ultra violet (UV) light to remove smell and disinfect. U.S. Pat. No. 6,312,029 describes a litter box that uses a deodorizer and fan to mask the smell while U.S. Pat. No. 7,137,355 uses ozone. The add-on device in U.S. Pat. No. 8,797,166 calculates weight of the animal waste and communications to phone/internet. U.S. Patent Application 2007/0,125,306 provides one claim for a litter box to close when a radio frequency (RF) transponder on the animal comes close to the device.

Most litter boxes are steady state, designed to only hold litter. As mentioned, some prior art attempt to solve the problems but fail to fully address them. For example, automatic litter boxes like those disclosed in U.S. Pat. Nos. 8,757,094 and 6,082,302 do a good job of hiding the soiled litter in order to lower the smell, but they fail to understand what has broken the line of sight. The built-in sensors are designed only to detect that ‘something’ breaks the sensor's line of sight. These sensors cannot tell the difference between an animal, human, or inanimate object. Additionally, the motors can get stuck since the system does not know how much the clumps weigh. Exacerbating the problem, the motors and additional mechanics increase the size of the litter box significantly, inconveniencing the owners. Not only are the solutions expensive but the problems they fail to address are compounded in a multi-pet household. Therefore, a need still exists for an accurate, intelligent, and low-cost solution that does not only rely on a rake to safely remove odor.

Although the device disclosed in U.S. Pat. No. 8,347,819 uses UV light to disinfect and reduce smell, the product is flawed since it is an open design. This system exposes the UV light and can blind the animal, as well as cause UV damage to nearby humans. Once the animal leaves the litter box and breaks the sensor beam, the litter box turns on the UV light without knowing how far the animal is relative to the litter box. In addition, the sensor is not intelligent enough to know the difference between an animal, human, or inanimate object (a child or dog could be near the litter box). Although UV light has shown to decrease bacteria, all smell will not necessarily be removed from an open-aired box since the UV light can directly escape and reflect/refract outside of the box. There is still a need for a safe UV light based solution that accurately detects when a particular animal is using the litter box and protects all occupants of the house when being used.

The device disclosed in U.S. Pat. No. 4,030,449 uses a spray cartridge to help suppress odor in a litter box but requires the user to manually press the freshener. Unfortunately, this solution is inconvenient to the user and doesn't control the odor, since often the pet owner is not home when the animal soils the litter box. Therefore, a need still exists for a litter box with an automatic sprayer for disinfection and odor suppression.

The device disclosed in U.S. Pat. No. 8,797,166 can weigh bowel movements but must be placed underneath the litter box rather than integrated into the litter box. Although it claims to recognize the animals based on weight and motion physiology, it is very difficult to do correctly since it only monitors the steps of the animal inside the box. If the animals are of similar weight or gait, the system can fail to distinguish between them. This device will also make the overall litter box much larger, inconveniencing owners with small apartments/houses. There is a need to have a more accurate, self-contained, compact detector of the animals using the litter box that can weight soiled litter and/or animals.

Although automatic litter boxes as disclosed in U.S. Pat. No. 8,757,094 can clean litter clumps and reduce exposure to pathogens, often some of the clumps are left behind, requiring the user to scrape the litter box causing potential harmful exposure. Most other litter boxes, like those disclosed in U.S. Pat. Nos. 3,831,557 and 8,578,887, require manual scooping of the clumps in an open-air fashion. There is a need for the ability to manually remove litter clumps without being exposed to the pathogens in the air or through accidental handling of litter (produced by open litter boxes).

Some litter boxes like those disclosed in U.S. Pat. Nos. 3,831,557 and 6,332,429 try to use high walls or enclosures to prevent litter from being kicked out and contaminating the house. Unfortunately, this requires the litter boxes to be very large and bulky, inconveniencing owners with small apartments or houses. This solution is insufficient, therefore there is still a need to make a litter box that is compact and prevents litter from contaminating the rest of the house when the animal kicks up the litter inside the litter box.

It is to these ends that the present invention has been developed.

### BRIEF SUMMARY OF THE INVENTION

To minimize the limitations in the prior art, and to minimize other limitations that will be apparent upon reading and understanding the present specification, the present invention describes an intelligent litter box that regulates access by opening and closing in order to suppress odor, disinfect contents, monitor frequency and weight of waste, and shrink litter box size.

It is an objective of the present invention to provide an intelligent litter box that comprises intelligent components.

It is another objective of the present invention to provide an intelligent litter box that incorporates recognition technologies.

It is another objective of the present invention to provide an intelligent litter box that automatically opens and closes.

It is another objective of the present invention to provide an intelligent litter box that suppresses odors.

It is another objective of the present invention to provide an intelligent litter box that converts to a smaller size.

It is another objective of the present invention to provide an intelligent litter box that incorporates wireless technologies.

It is another objective of the present invention to provide an intelligent litter box that automatically self-cleans.

It is another objective of the present invention to provide an intelligent litter box that reports frequency and volume of waste production.

It is another objective of the present invention to provide an intelligent litter box that identifies individual animals.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates a perspective view of a first embodiment of an intelligent litter box in a closed orientation.

FIG. 2 illustrates a perspective view of a first embodiment of an intelligent litter box in a closed orientation with its integrated plough extended.

FIG. 3 illustrates a perspective view of a first embodiment of an intelligent litter box in an open orientation.

FIG. 4 illustrates an exploded view of a first embodiment of an intelligent litter box.

FIG. 5 illustrates a perspective view of a second embodiment of an intelligent litter box in a closed orientation.

FIG. 6 illustrates an exploded view of a second embodiment of an intelligent litter box.

FIG. 7 illustrates a perspective view of a second embodiment of an intelligent litter box in an open orientation.

FIG. 8 illustrates a perspective view of a third embodiment of an intelligent litter box in a closed orientation.

FIG. 9 illustrates a perspective view of a third embodiment of an intelligent litter box in an open orientation.

FIG. 10 illustrates a front view of a third embodiment of an intelligent litter box in an open orientation.

FIG. 11 schematically illustrates a method for training animals authorized to use an intelligent litter box.

FIG. 12 schematically illustrates a method for detecting animals authorized to use an intelligent litter box.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention relates in general to litter boxes, and, more specifically, to an intelligent litter box that regulates access by opening and closing in order to suppress odor, disinfect contents, monitor frequency and weight of waste, and shrink litter box size. As contemplated by the present disclosure, the intelligent litter box comprises intelligent components such as image recognition and feature points to identify different animals that are authorized or excluded from use. Along with authorizing use of the intelligent litter box, the invention automatically closes to restrict access or opens to allow access. The invention also reduces odors that emanate from the soiled litter. The intelligent litter box also converts into a smaller size in order to relieve the owner of cumbersome dimensions. The litter box also has a user interface on board but can also be accessed remotely via the internet, cell phones, tablets, and other smart devices. In a preferred embodiment, the system provides an easy manual or automatic method of cleanup once authorization and detection has been enacted. In another preferred embodiment the system provides frequency and weight of waste for particular animals using the intelligent components to discern the particular animals.

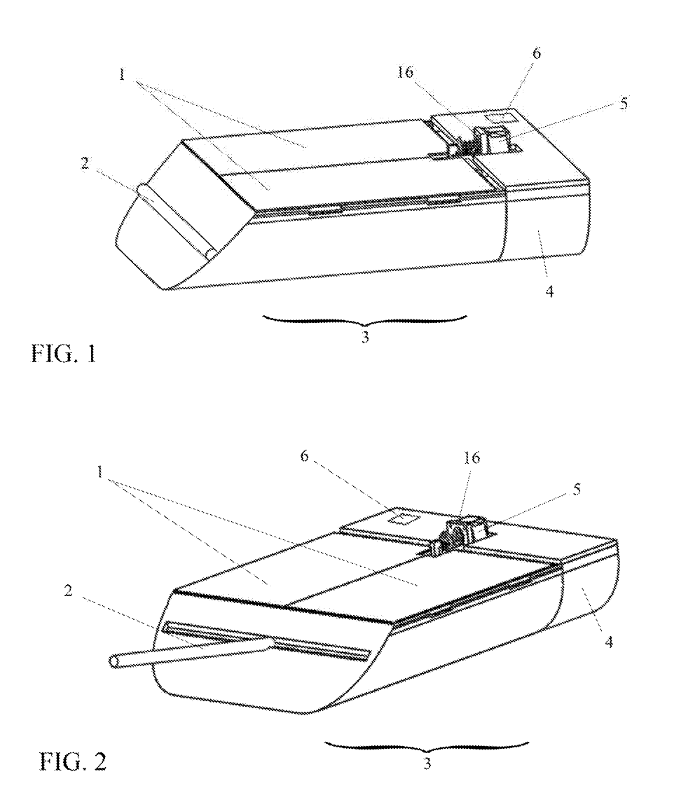

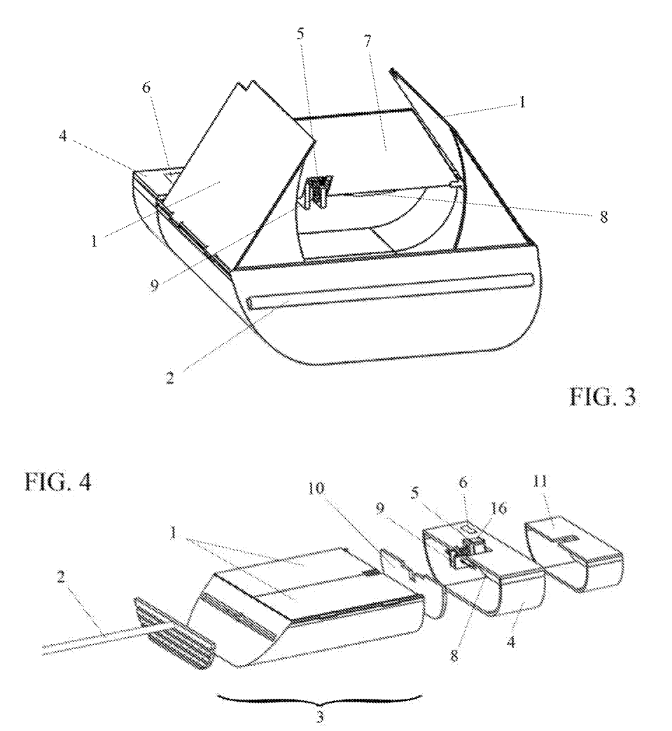

FIGS. 1 through 4 illustrate a first embodiment of an intelligent litter box, as contemplated by the present disclosure. The figures identify a plurality of cover flaps 1, a plough 2, a first main body 3, a component housing 4, a drive mechanism 5, an electronic user interface 6, a deflector flap 7, a light module 8, a spray module 9, a separator flap 10, an end cap 11, and a camera 16. The camera 16 is orientated such that it has an unobstructed 360-degree view of the surrounding area whether the intelligent litter box is in its open or closed orientation. The camera 16 may identify authorized animals in the vicinity of the intelligent litter box, and may comprise any appropriate sensing means such as infrared (IR), thermal imaging, light detection and ranging (LIDAR), radio detection and ranging (RADAR), night vision, or a combination thereof. The combination may further implement a tag or marker that may be attached to or carried by an authorized animal and that may be sensed and identified by the camera 16. The sensing of an authorized animal by the camera 16 may trigger the opening of the plurality of cover flaps 1, thus allowing access to the litter in the system.

With an onboard camera and processor system, the intelligent litter may further comprise additional functions. For example, the system may provide stop-motion detection in order to store security footage of long periods of movement activation into a small file size and viewing time. Gesture recognition algorithms may be employed to allow a user to interact with the system using hand gestures to command the litter box. A microphone may be added to the system to receive audio commands issued by the user. With internet connectivity the user may interact remotely with their animal(s) by means of a controllable laser toy.

The first main body 3, component housing 4, and end cap 11 generally comprise the base structure of the intelligent litter box, with the plurality of cover flaps 1 attached to the first main body 3. The plough 2 may be attached within the first main body 3, and may be designed to push waste products left in the litter into the component housing 4 and end cap 11. The handle of the plough 2 may be reducible by any appropriate means, such as telescoping, folding, or collapsing. The separator flap 10 may be moved by the pushing action of the plough 2 through the system. The separator flap 10 may be connected by any appropriate tensioning means, such as springs, bands, hydraulics, or pistons, and may thus return to its original position. A sensor may be integrated into the separator flap 10 to determine the timing and frequency of waste depositing and may further notify the user of the need for cleaning the system. A disposable bag or box may be placed into the end cap 11, or the end cap 11 may comprise a disposable design, for ease of cleaning.

The plurality of cover flaps 1 and deflector flap 7 may lift up to prevent litter from being kicked out of the system, and may close to seal the system and prevent the emanation of odors. The various flaps may be opened and closed by any appropriate means, such as hydraulics, pistons, belts, or gears. The closing of the flaps further prevents the emission of light from the light module 8, which may be ultraviolet (UV) light, and the escaping of litter pathogens. The light module 8 may be activated when the various flaps are closed and the system is sealed. The spray module 9 may be attached internally or externally to the component housing 4, and may be activated when the various flaps are closed and the system is sealed.

The drive mechanism 5 may comprise any appropriate geared motor using, for example, worm gears or spiral gears to open and close the various flaps. The gears may be connected directly to the flaps, though are preferably connected indirectly to the various flaps by rods or cords so that a failure of the drive mechanism 5 will not trap an animal inside the system. When attached indirectly, the various flaps will remain open or loosely closed such that the flaps may still be opened.

The system may further comprise an electronic user interface 6 that allows users to access, update, and modify the functions and parameters of the intelligent litter box. The electronic user interface 6 may comprise a liquid crystal display (LCD), organic light-emitting diode (OLED), or touchscreen. In some embodiments the electronic user interface 6 may be remotely accessible via a cellphone, tablet, or computer.

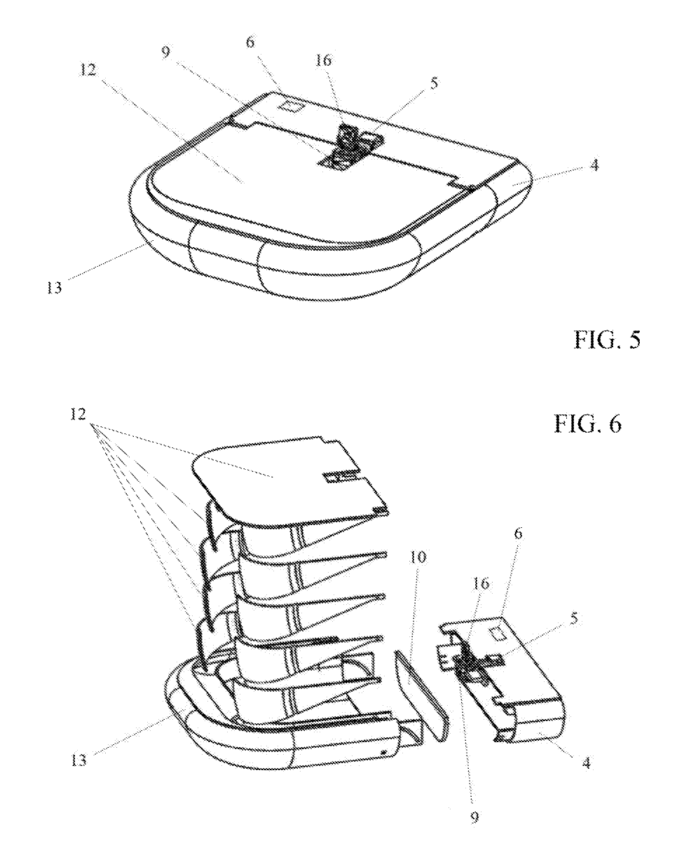

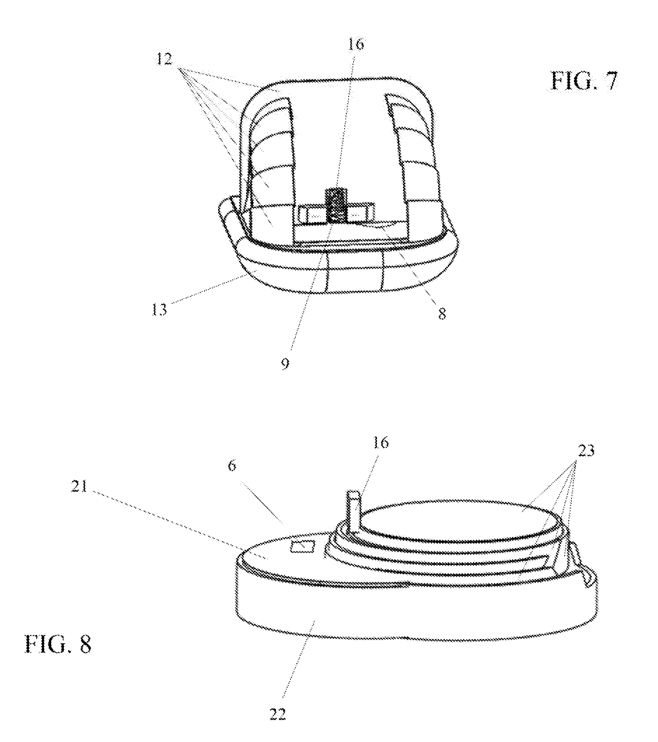

FIGS. 5 through 7 illustrate a second embodiment of an intelligent litter box, as contemplated by the present disclosure. The second embodiment replaces the plurality of cover flaps 1 with accordion flaps 12, which may raise and lower in a single expanding motion, and the first main body 3 with a second main body 13.

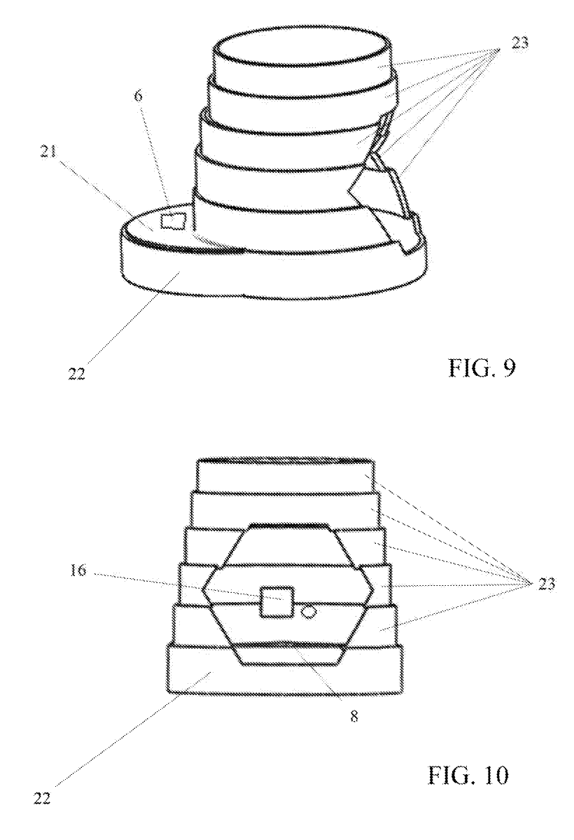

FIGS. 8 through 10 illustrate a third embodiment of an intelligent litter box, as contemplated by the present disclosure. The third embodiment replaces the plurality of cover flaps 1 with telescoping flaps 23, which may raise and lower in a single telescoping motion, and the first main body 3 with a third main body 22. The component housing 4 and end cap 11 may be replaced with a single removable housing 21.

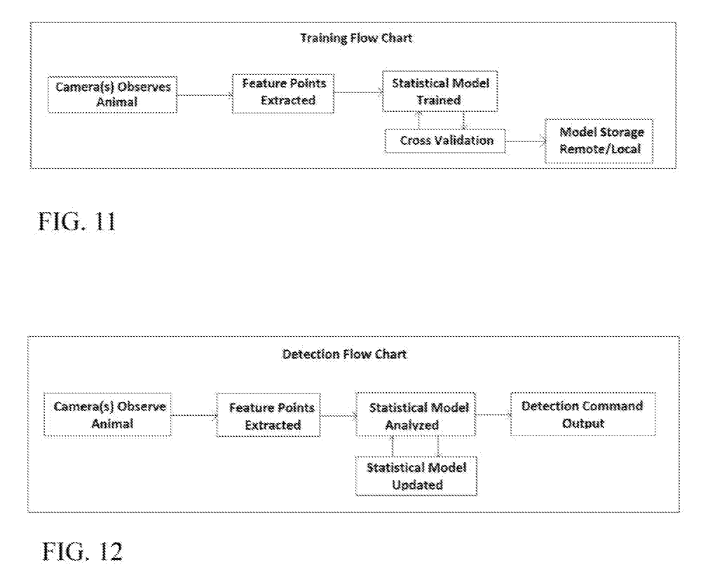

FIG. 11 shows the flow chart of how the authorized animal is trained on the system. First, an authorized animal is presented either to the camera or uploaded from prior photos taken by a smart device like a phone. Feature points are then extracted from either the image sensor(s) and/or LIDAR data points in a data fusion. A statistical model is generated from this data. Finally the system cross validates the model using the series of images. The analysis can take place in the cloud, internally, or on smart devices. Continuous training will provide robustness to the algorithms.

FIG. 12 shows the flow chart of how an authorized animal is detected. First, an authorized animal is presented either to the camera or uploaded from prior photos taken by a smart device like a phone. Feature points are then extracted from either the image sensor(s) and/or LIDAR data points in a data fusion. Then the trained statistical model is computed with this data. The analysis can take place in the cloud, internally, or on smart devices. Continuous training will provide robustness to the algorithms.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. An intelligent litter box combination, comprising:
a main body;
a plurality of flaps;
a component housing;
a drive mechanism;
a camera;
a control board;
a microprocessor; and
a data storage means;
wherein said data storage means and said microprocessor are installed on said control board;
wherein said camera, said control board, and said drive mechanism are installed in said component housing;
wherein said component housing is attached to said main body such that they form a continuous assembly;
wherein said plurality of flaps are attached to said main body such that they form a cover granting access to an interior chamber of said main body when opened;
wherein said plurality of flaps are attached to said drive mechanism such that said drive mechanism causes the opening of said plurality of flaps when activated; and
wherein said plurality of flaps are attached to said main body such that they form a cover denying access to said interior chamber of said main body when closed.

2. The invention of claim 1, further comprising:
a plurality of feature points;
wherein said plurality of feature points are associated with an authorized animal;
wherein said plurality of feature points identify an authorized animal;
wherein said plurality of feature points are stored in said data storage means;
wherein said plurality of feature points are read by said camera; and
wherein said reading of said plurality of feature points by said camera causes the intelligent litter box to recognize said authorized animal and causes said plurality of flaps to open and allow said animal access to said interior chamber of said main body.

3. The invention of claim 2, further comprising:
a weight sensor;
wherein said weight sensor is installed in said main body;
wherein said weight sensor detects a change in weight of a volume of litter contained within said main body; and
wherein said weight sensor records said change in weight of said volume of litter and associates said recording with said plurality of feature points associated with said authorized animal; and
wherein said recording is stored in said data storage means.

4. The invention of claim 3, further comprising:
a spray mechanism;
wherein said spray mechanism is activated after said plurality of flaps are closed and after said authorized animal has used the intelligent litter box.

5. The invention of claim 4, further comprising:
a light module;
wherein said light module is activated after said plurality of flaps are closed and after said authorized animal has used the intelligent litter box.

6. The invention of claim 5, further comprising:
an electronic user interface;
wherein said electronic user interface is installed on said component housing;
wherein said electronic user interface allows a user to control a plurality of functions associated with the intelligent litter box; and
wherein said electronic user interface displays a plurality of status parameters associated with the intelligent litter box.

7. The invention of claim 6, further comprising:
a wireless device;
wherein said wireless device is installed in said component housing; and
wherein said wireless device transmits and receives a plurality of data packets associated with said plurality of functions and said plurality of status parameters associated with the intelligent litter box.

8. The invention of claim 7,
wherein said wireless device comprises a Bluetooth device;
wherein said wireless device connects to a proprietary software application installed on a computing device;
wherein said proprietary software application displays said plurality of status parameters associated with the intelligent litter box;
wherein said proprietary software application displays said plurality of functions associated with the intelligent litter box; and
wherein said proprietary software application transmits a plurality of user instruction to the intelligent litter box.

9. The invention of claim 8, further comprising:
an end cap;
wherein said end cap is attached to said component housing such that they form a continuous assembly.

10. The invention of claim 9, further comprising:
a plough;
wherein said plough is installed in said main body; and
wherein said plough may be pushed through said main body to move animal waste from said interior chamber of said main body to an interior chamber of said end cap.

11. The invention of claim 10,
wherein said end cap is disposable.

12. The invention of claim 8,
wherein said camera comprises an infrared sensor.

13. The invention of claim 8,
wherein said camera comprises a light detection and ranging sensor.

14. The invention of claim 8,
wherein said camera comprises a radio detection and ranging sensor.

15. The invention of claim 8,
wherein said camera comprises a night vision sensor.

16. The invention of claim 8,
wherein said spray mechanism comprises a spray disinfectant.

17. The invention of claim 8,
wherein said light module comprises an ultraviolet light.

18. The invention of claim 8, further comprising:
a modular laser attachment.

19. The invention of claim 8, further comprising:
a microphone attachment.

20. The invention of claim 19,
wherein said microphone attachment is installed on said component housing; and
wherein said microphone attachment allows a user to control a plurality of functions associated with the intelligent litter box.
